(19) United States
(12) Patent Application Publication
(10) Pub. No.: US 2017/0105106 A1
(43) Pub. Date: Apr. 13, 2017

(54) EARLY-WARNING SYSTEM FOR DISASTERS

(71) Applicant: HSIANG-FONG TSAI, TAIPEI CITY (TW)

(72) Inventor: HSIANG-FONG TSAI, TAIPEI CITY (TW)

(21) Appl. No.: 15/383,119

(22) Filed: Dec. 19, 2016

Related U.S. Application Data
(63) Continuation-in-part of application No. 15/000,681, filed on Jan. 19, 2016.

(30) Foreign Application Priority Data
Jan. 19, 2015 (TW) 104101713

(51) Int. Cl. H04W 4/22

(52) U.S. Cl. CPC H04W 4/22; H04W 4/023

(57) ABSTRACT

An early-warning system for disasters includes one sensor, a response personnel database, a position retrieving module for communication devices, a primary control module, and a warning communication module. The sensor is utilized for detecting a disaster hint parameter; the response personnel database records a plurality of response personnel groups, and each response personnel group records at least one communication data of the communication device used by at least one response person; the position retrieving module for communication devices is utilized for detecting the position of each of the communication devices; the primary control module uses the disaster hint parameter to determine the disaster hint worsening level and the disaster treating range so as to have the warning communication module transmitting the response notice data to the communication device.

### REFERENCE TO RELATED APPLICATION

This Application is being filed as a Continuation-in-Part Application of Ser. No. 15/000,681 filed on 19 Jan. 2016, currently pending.

### BACKGROUND OF INVENTION 1. Field of the Invention

The invention relates to an early-warning system for disasters, and more particularly to the early-warning system for disasters that introduces disaster-sign factors to determine the disaster class and the pre-disaster-management regime and further to provide users the pre-disaster-management reminder information.

2. Description of the Prior Art

Generally speaking, versatile gas detectors and fire alarms are usually seen indoors and outdoors in lots of private and/or public buildings, mainly for generating alarms to alert people while in meeting a gas leak or a fire. However, while the gas detector or the fire alarm detects a gas leak or fire smokes, it is a usual case that the gas leak and/or the fire have been there for a while. In addition, while hearing the alarm, people usually panic, but not calm down, in handling the necessary escape. Thereupon, precious time for managing the disaster and for the escape is usually missed, and thus plenty loss in properties and lives is inevitable.

### SUMMARY OF THE INVENTION

In view of the aforesaid prior art, since current gas detectors and fire alarms are mainly to detect the gas or the fire smoke so as further to determine if meeting a gas leak or a fire, thus an inevitable delay in confirming the gas leak and the fire exists before the gas detector and the fire alarm can detect the gas leak and the fire. Further, while people in hearing the alarm, panics prevail to fail people in handling the escape calmly. Sadly, loss due to the disaster is inevitable.

Accordingly, a main object of the present invention is to provide an early-warning system for disasters, which uses the sensor to detect whether there exists an disaster hint with the possibility to be worsened as a disaster, and notifies the user to do the corresponding treatment when the disaster hint is detected so as to prevent the happening of the disaster.

As mentioned, an early-warning system for disasters is provided in accordance with an embodiment of the present invention. The early-warning system is used for transmitting an early-warning signal to at least one of a plurality of communication devices during an early-warning period in which a disaster hint becomes a disaster event. The disaster event belongs to at least one of a plurality of disaster types. The early-warning system comprises at least one sensor, a response personnel database for disasters, a position retrieving module for communication devices, a primary control module, and a warning communication module.

The sensor is utilized for detecting at least one disaster hint parameter at a monitored position corresponding to at least one of the disaster types, and defining a disaster hint worsening level of the early-warning period corresponding to at least one of the disaster types accordingly.

The response personnel database for disasters records a plurality of response personnel groups for disasters. Each response personnel group is corresponding to at least one of the disaster types and predetermines a personnel attribute priority for at least one of the disaster types respectively such that a plurality of different personnel attribute priorities is predetermined. Each response personnel group records at least one communication data of the communication device used by at least one response person.

The position retrieving module for communication devices is utilized for detecting a communication device position of the at least one communication device used by the at least one response person for each of the response personnel groups such that a plurality of the communication device positions is retrieved.

The primary control module is communicated with the sensor and the position retrieving module for communication devices, and comprises a hint classification database for disasters, a response database for disasters, and a processing unit.

The hint classification database for disasters has a hint classification rule for disasters, which defines a plurality of disaster treating spaces according to the monitored position, the disaster types, and the disaster hint worsening level corresponding to each of the disaster types, and each of the disaster treating spaces predetermines a response space priority such that a plurality of different response space priorities is predetermined.

The response database for disasters stores at least one response notice data corresponding to the disaster types, the disaster hint worsening level, and the disaster treating space.

The processing unit is electrically connected to the hint classification database for disasters, the response database for disasters, and the position retrieving module for communication devices, and decides a communication order of the communication devices according to the personnel attribute priority and the response space priority when determining that the communication devices are located in at least one of the disaster treating spaces, retrieves the communication data of the communication devices within the disaster treating spaces according to the communication order, and transmits the early-warning signal.

The warning communication module is communicated with the processing unit for receiving the early-warning signal and transmitting the response notice data to the communication devices according to the communication order and the communication data.

As mentioned, because the primary control module is capable to determine the type, range and remaining time of the disaster based on the detected disaster hints, retrieve the positions of the communication devices used by the response persons by using the communication device position retrieving module so as to transmit the early-warning signal to the communication devices located in the disaster treating space, the response persons can do the corresponding treatments in advance to prevent the happening of disasters effectively.

In accordance with a preferred embodiment of the present invention, the response database for disaster further stores at least one disaster prohibiting tool to prohibit the disaster hint from becoming the disaster event and at least one tool location of the disaster prohibiting tool, and the response notice data includes the at least one disaster prohibiting tool and the at least one tool location.

In accordance with a preferred embodiment of the present invention, the early-warning system further comprises a person location detecting module communicated with the primary control module. The person location detecting module includes a human body infrared sensor, which is communicated with the primary control module, for detecting the status of at least one of the response persons. The disaster treating spaces include a scene. When at least one of the response persons stays at the disaster scene and the status is motion, the primary control module transmits a stop sensing signal to the sensor to have the sensor stop sensing the at least one disaster hint parameter.

In accordance with a preferred embodiment of the present invention, the primary control module further comprises a transmitting condition judging unit, which has the warning communication module stop transmitting the response notice data when the primary control module receives a prohibited signal transmitted by at least one of the communication devices.

In accordance with a preferred embodiment of the present invention, the position retrieving module for communication devices is utilized for detecting positions of the communication devices for each of the response personnel groups by using positioning technology of the communication devices.

In accordance with a preferred embodiment of the present invention, the sensor is an infra-red temperature sensor or a gas sensor.

In accordance with a preferred embodiment of the present invention, the primary control module further comprises a timer, which is electrically connected to the processing unit and begins to count down when the processing unit transmits the early-warning signal.

In accordance with a preferred embodiment of the present invention, when the processing unit determines that one of the communication devices is located in the disaster treating spaces, the processing unit further retrieves the corresponding communication data of the communication devices in the disaster treating spaces, and transmits the early-warning signal.

In accordance with a preferred embodiment of the present invention, the primary control module further comprises a disaster worsening assessing unit, and the disaster worsening assessing unit accesses a response time limit corresponding to the early-warning period according to the disaster hint worsening level corresponding to at least one of the disaster types.

As mentioned, because the primary control module is capable to determine the type, range and remaining time of the disaster based on the detected disaster hints, retrieve the positions of the communication devices used by the response persons by using the communication device position retrieving module so as to transmit the early-warning signal to the communication devices located in the disaster treating space, the response persons can do the corresponding treatments in advance to prevent the happening of disasters effectively.

All these objects are achieved by the early-warning system for disasters described below.

### BRIEF DESCRIPTION OF THE DRAWINGS

The present invention will now be specified with reference to its preferred embodiment illustrated in the drawings, in which:

FIG. 1 is a schematic view of an early-warning system for disasters provided in accordance with a preferred embodiment of the present invention;

FIG. 2 is a 3D schematic view of a disaster treating space defined by the hint classification rule for disasters according to the monitored position, the disaster types, and the disaster hint worsening level corresponding to the disaster types in accordance with the present invention;

FIG. 3 and FIG. 4 are planar schematic views of a disaster treating space defined by the hint classification rule for disasters according to the monitored position, the disaster types, and the disaster hint worsening level corresponding to the disaster types in accordance with the present invention;

FIG. 5 is a diagram showing the temperature detected by the sensor every minute and the estimated remaining time in accordance with the present invention; and

FIG. 6 is a planar schematic view showing the communication device displaying the response notice data transmitted by the warning communication module provided in accordance with the present invention.

### DESCRIPTION OF THE PREFERRED EMBODIMENT

The invention disclosed herein is directed to an early-warning system for disasters. In the following description, numerous details are set forth in order to provide a thorough understanding of the present invention. It will be appreciated by one skilled in the art that variations of these specific details are possible while still achieving the results of the present invention. In other instance, well-known components are not described in detail in order not to unnecessarily obscure the present invention.

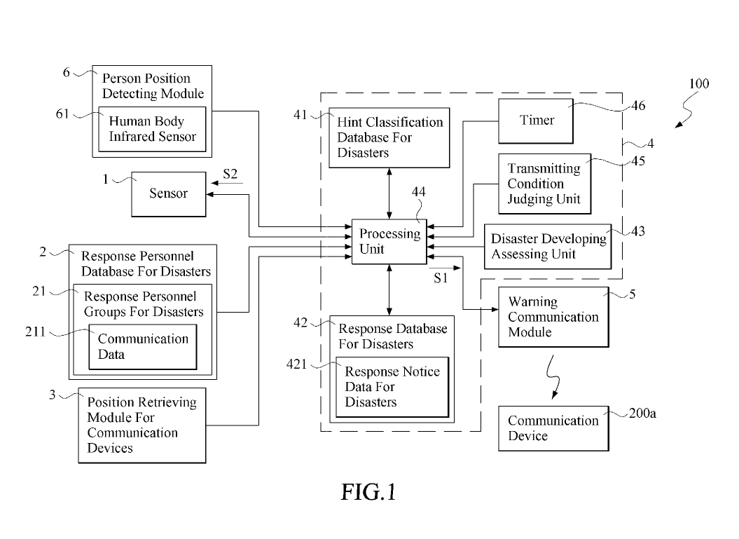

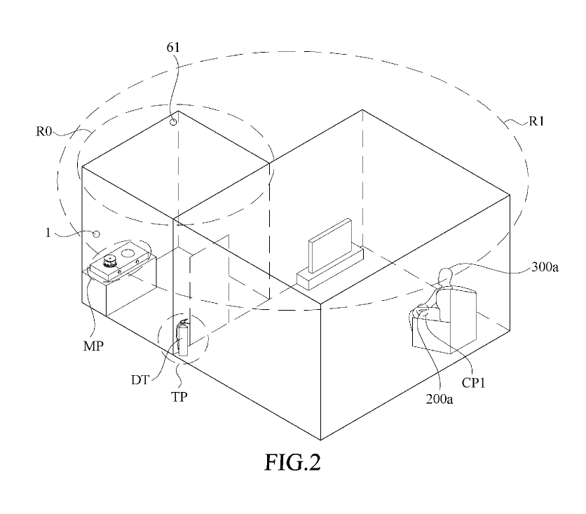

Please refer to FIGS. 1 and 2, wherein FIG. 1 is a schematic view of an early-warning system for disasters provided in accordance with a preferred embodiment of the present invention, and FIG. 2 is a 3D schematic view of a disaster treating space defined by the hint classification rule for disasters according to the monitored position, the disaster types, and the disaster hint worsening level corresponding to the disaster types in accordance with the present invention.

As shown, the early-warning system for disasters 100 comprises a sensor 1, a response personnel database 2, a position retrieving module 3 for communication devices, a primary control module 4, and a warning communication module 5.

The sensor 1 is utilized for detecting a disaster hint parameter sp corresponding to a disaster hint at a monitored position MP. In the present embodiment, the sensor 1 is an infrared temperature sensor, the monitored position MP is the gas oven. The monitored position MP is corresponding to the fire among the various types of disasters, and the hint of the fire is the high temperature or the high rising speed of temperature. However, the present invention is not so restricted. For example, as the disaster type is the gas explosion, the sensor 1 can be a gas sensor, the monitored position MP can be the ground, and the disaster hint of gas explosion is the high gas concentration or the high rising speed of gas concentration; and as the disaster type is the flood, the sensor 1 can be a water level sensor, the monitored position MP can be the wall surface, and the disaster hint of flood is the high water level or the high rising speed of water level.

The following table 1, a plurality of disaster hint parameters sp corresponding to the disaster hints are defined according to the disaster types and the corresponding disaster hints in accordance with the present invention.

TABLE 1
comparison table of disaster types and disaster hint parameters

| Disaster types | | Fire | Gas explosion | Flood |
|---|---|---|---|---|
| Disaster | Temperature | V | | |
| hint | Rising speed of temperature | V | | |
| parameter | Gas concentration | | V | |
| | Rising speed of gas | | V | |
| | concentration | | | |
| | Water level | | | V |
| | Rising speed of water level | | | V |
| | Estimated remaining time | V | V | V |

The response personnel database 2 records a plurality of response personnel groups 21 (only one group is shown), and each of the response personnel group records a communication data 211 of the communication devices 200a used by a plurality of response persons (only one response person 300a is shown in FIG. 2). In the present embodiment, the response personnel group 21 includes the response persons 300a shown in the following table 2.

TABLE 2
comparison table of response personnel groups

| Response personnel group | Response person |
|---|---|
| Families | Child |
| | Adult |
| | Senior |
| Friends and relatives | Relative |
| | Friend |
| Neighborhood | Neighbor |
| | Community guard |
| | Village head |
| Disaster relief unit | Fire department |
| | Police office |

As mentioned, each of the response personnel groups 21 is corresponding to at least one of a plurality of disaster types, and predetermines a personal attribute priority for at least one of a plurality of the disaster types such that a plurality of personal attribute priorities are predetermined as shown in the following table 3.

TABLE 3
comparison table of personal attribute priority

| | | Disaster type | | |
|---|---|---|---|---|
| Personal attribute priority | | Fire | Gas explosion | Flood |
| Response person | Child | 0 | 0 | 3 |
| | Adult | 5 | 5 | 5 |
| | Senior | 1 | 2 | 3 |
| | Relative | 4 | 4 | 1 |
| | Friend | 4 | 4 | 1 |
| | Neighbor | 3 | 3 | 3 |
| | Community guard | 3 | 3 | 3 |
| | Village head | 2 | 2 | 3 |
| | Fire department | 3 | 3 | 2 |
| | Police office | 1 | 1 | 2 |

The child described in the above mentioned response person are those with the ability to operate the communication device (e.g. the communication device 200a in FIG. 2) such as the mobile phone, and the table shows that the priority of child with respective to the disaster type of fire and gas explosion is 0, which indicates that the child only response to the flood among the three disasters.

The position retrieving module 3 of communication device is utilized for detecting the communication-device position CP1 of a communication device 200a used by a response person 300a of the response personnel group 21. Because the position retrieving module 3 is capable to detecting a plurality of response persons (including the response person 300a) of a plurality of response personnel groups 21, a plurality of communication-device positions CP1 would be found (only one is shown in the figure). In the present embodiment, the position retrieving module 3 uses the positioning technology of communication devices to detect the communication-device position CP1 of the communication device used by the response person 300a of the response personnel group 21, such as global positioning system (GPS) technology. In addition, the “communication device 200a used by the response person 300a” indicates “the communication device 200a held or carried by the response person 300a” or “the communication device 200a available and usable by the response person 300a in a short time”.

The primary control module 4 is communicated with the sensor 1, the response personnel database 2, and the position retrieving module 3, and the primary control module 4 includes a hint classification database 41, a response database 42, a disaster worsening assessing unit 43, a processing unit 44, and a transmitting condition judging unit 45.

The hint classification database 41 has a hint classification rule according to the disaster hints so as to classify the disaster hint parameters sp relative to each of the disaster types into various disaster hint worsening levels according to the high classification rule. In the present embodiment, the disaster types of fire, gas explosion and flood are described as shown in the following tables 4, 5, and 6.

TABLE 4
comparison table of disaster hint parameters of fire
Disaster type Fire

| | Disaster hint parameter | | |
|---|---|---|---|
| | | Rising speed of | Estimated |
| | Temperature | temperature | remaining |
| Classification value | (° C.) | (° C./min) | time (min) |
| Safety threshold value | t1 = 50 | tr1 = 5 | ft1 = 60 |
| Low warning value | t2 = 80 | tr2 = 20 | ft2 = 20 |
| Medium warning value | t3 = 100 | tr3 = 50 | ft3 = 5 |
| Disaster threshold value | t4 = 150 | tr4 = 100 | ft4 = 2 |

As shown, in the present embodiment, the monitored position is the gas oven, the classification values such as the safety threshold value, the low warning value, the medium warning value, and the disaster threshold value are set based on the disaster hint parameters sp such as temperature, rising speed of temperature, and estimated time of the gas oven which may cause fire, and such classification values can be compared with the disaster hint parameters received by using the sensor 1 to detect the monitored position. The safety threshold value indicates the value the disaster hint starts; the disaster threshold value indicates the value with highly possible to cause disaster immediately; the low warning value and the medium warning value indicate the classification values between the safety threshold value and the disaster threshold value.

In practice, the sensor 1 may be set to detect the temperature once per minute, such that the real-time temperature st at every minute can be detected, the real-time temperature rising speed tr can be calculated by using the real-time temperature st at every minute, and the real-time estimated remaining time ft can be calculated by using the real-time temperature rising speed tr and the disaster threshold value t4. For example, in the present embodiment, as the detected real-time temperature is 50° C. and the real-time temperature rising speed tr is 20° C./min, the real-time and the disaster threshold value t4 can be used to calculate the real-time estimated remaining time ft as (150° C.−50° C.)/20° C./min=5 min, that is, if the temperature rising speed tr remains the same, the temperature 150° C. of the disaster threshold value t4 would be reached in 5 min.

TABLE 5
comparison table of disaster hint parameters of gas explosion
Disaster type Gas explosion

| | Disaster hint parameter | | |
|---|---|---|---|
| | Gas | Rising speed of | Estimated |
| | concentration | gas concentration | remaining |
| Classification value | (vol. %) | (vol. %/s) | time (min) |
| Safety threshold value | g1 = 1 | gr1 = 0.1 | bt1 = 60 |
| Low warning value | g2 = 2 | gr2 = 0.2 | bt2 = 30 |
| Medium warning value | g3 = 5 | gr3 = 0.3 | bt3 = 10 |
| Disaster threshold value | g4 = 7 | gr4 = 0.5 | bt4 = 5 |

As mentioned, in accordance with another embodiment of the present invention, as the early-warning target is changed to the disaster type of gas explosion, the classification values are set according to the disaster hint parameters sp such as gas concentration, rising speed of gas concentration, and estimated remaining time, and the real-time gas concentration sg detected by the sensor 1 is used to calculate the real-time rising speed of gas concentration gr and the real-time estimated remaining time bt. The calculation is similar to that used for calculating the real-time temperature rising speed tr and the real-time estimated remaining time ft using the real-time temperature st, and thus is not repeated here.

In addition, in accordance with another embodiment of the present invention, the sensor 1 may be a flammable gas sensor, for example, as the flammable gas to be detected by the sensor 1 is the liquefied petroleum gas, the sensor 1 may be located on the wall close to the ground because the specific gravity of liquefied petroleum gas is higher than the air.

TABLE 6
comparison table of disaster hint parameters of flood
Disaster type Flood

| | Disaster hint parameter | | |
|---|---|---|---|
| | | Rising speed of | Estimated |
| | Water level | water level | remaining |
| Classification value | (cm) | (cm/hr) | time (min) |
| Safety threshold value | h1 = 0 | hr1 = 0 | wt1 = 120 |
| Low warning value | h2 = 5 | hr2 = 10 | wt2 = 60 |
| Medium warning value | h3 = 10 | hr3 = 20 | wt3 = 30 |
| Disaster threshold value | h4 = 20 | hr4 = 40 | wt4 = 20 |

As mentioned, in accordance with another embodiment of the present invention, as the early-warning target is changed to the disaster type of flood, the classification values are set according to the disaster hint parameters sp such as water level, rising speed of water level, and estimated remaining time, and the real-time water level sh detected by the sensor 1 is used to calculate the real-time rising speed of water level hr and the real-time estimated remaining time wt. The calculation is similar to that used for calculating the real-time temperature rising speed tr and the real-time estimated remaining time ft using the real-time temperature st, and thus is not repeated here.

As mentioned, it is understood that, for each of the disaster types, at least one disaster hint parameter sp which may influence the worsening of disaster hint is defined, and a plurality of classification levels are set based on different disaster types, thereby, a plurality of disaster hint worsening levels may be defined based on the classification values as shown in the following table 7.

TABLE 7
comparison table of classification values of disaster
hint parameters and disaster hint worsening levels

| | | Disaster hint worsening levels | | | |
|---|---|---|---|---|---|
| | | Safe | Low | Medium | High |
| Disaster | Fire | st ≦ t1 | t1 < st ≦ t2 | t2 < st ≦ t3 | t3 < st ≦ t4 |
| type | | tr ≦ tr1 | tr1 < tr ≦ tr2 | tr2 < tr ≦ tr3 | tr3 < tr ≦ tr4 |
| | | et ≧ ft1 | ft1 > et ≧ ft2 | ft2 > et ≧ ft3 | ft3 > et ≧ ft4 |
| | Gas | sg ≦ g1 | g1 < sg ≦ g2 | g2 < sg ≦ g3 | g3 < sg ≦ g4 |
| | explosion | gr ≦ gr1 | gr1 < gr ≦ gr2 | gr2 < gr ≦ gr3 | gr3 < gr ≦ gr4 |
| | | et ≧ bt1 | bt1 > et ≧ bt2 | bt2 > et ≧ bt3 | bt3 > et ≧ bt4 |
| | Flood | sh ≦ h1 | h1 < sh ≦ h2 | h2 < sh ≦ h3 | h3 < sh ≦ h4 |
| | | hr ≦ hr1 | hr1 < hr ≦ hr2 | hr2 < hr ≦ hr3 | hr3 < hr ≦ hr4 |
| | | et ≧ wt1 | wt1 > et ≧ wt2 | wt2 > et ≧ wt3 | wt3 > et ≧ wt4 |

Based on the description in table 7, take fire for example, as the real-time temperature st received by using the sensor 1 to detect the monitored position MP is smaller than or equal to the temperature safety threshold value t1, the calculated real-time temperature rising speed tr is smaller than or equal to the safety threshold value tr1 of temperature rising speed, and the calculated estimated remaining time et is larger than the safety threshold value ft1 of estimated remaining time, it is represented that the monitored position MP detected by the sensor 1 is in the safe state; however, as the real-time temperature st, the real-time temperature rising speed tr, and the real-time estimated remaining time et rise to the regions among different disaster hint worsening levels, the highest disaster hint worsening level is focused.

For example, as the real-time temperature st is 50° C., the real-time temperature rising speed tr is 20° C./min, and the real-time estimated remaining time et is 5 min, although the real-time temperature st equals to the temperature safety threshold value t1 and corresponds to the safe disaster hint worsening level, the real-time temperature rising speed tr equals to the low warning value tr2 of temperature rising speed and corresponds to the low disaster hint worsening level, because the real-time estimated remaining time et equals to the medium waning value ft3 of estimated remaining time and corresponds to the medium disaster hint worsening level, the highest disaster hint worsening level, i.e. the medium disaster hint worsening level, would be put in the first place. That is, as the real-time temperature st is 50° C., the real-time temperature rising speed tr is 20° C./min, and the real-time estimated remaining time et is 5 min, the disaster hint worsening level would be judged as the medium level.

As mentioned, because the disaster hint worsening level detected by the sensor 1 would be determined as the highest one among the disaster hint worsening levels corresponding to the various disaster hints when judging the disaster hint parameters sp, i.e. the sensor 1 may detect four disaster hint worsening levels, i.e. high, medium, low, and safe, the primary control module 4 may proceed the judgment of the disaster hint worsening level even if the sensor 1 only detects one disaster hint parameter sp, but the judgment would be more strict as the type of disaster hints increases.

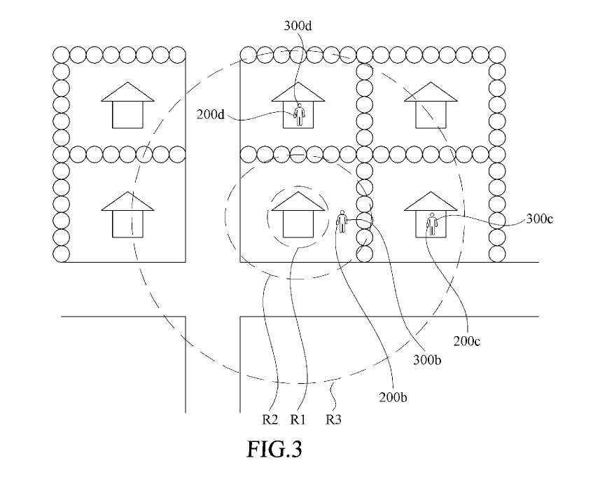

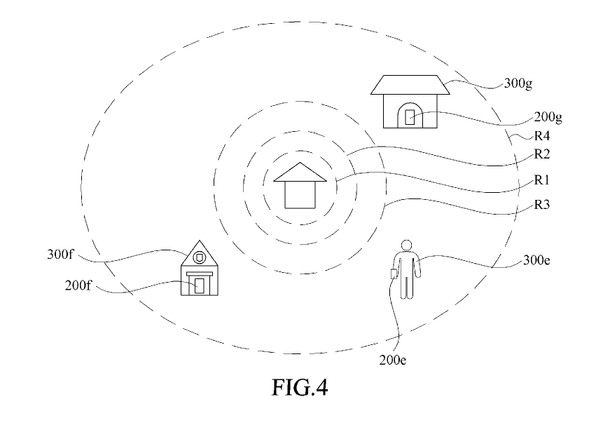

Please refer to FIGS. 2 to 4, wherein FIG. 3 and FIG. 4 are the planar schematic views of a disaster treating space defined by the hint classification rule for disasters according to the monitored position, the disaster types, and the disaster hint worsening level corresponding to the disaster types in accordance with the present invention.

As shown, the hint classification rule defines a plurality of disaster treating spaces such as the disaster scene R0, the interior space R1, the garden R2, the community R3, and the administrative area R4 as showing in the following table 8, and each of the disaster treating spaces has a predetermined response space priority such that a plurality of different response space priority is predetermined. The disaster treating spaces are not restricted to those described in the present embodiment and may be changed according to the need in practice.

TABLE 8
comparison table of disaster treating space and
response space priority

| | | Disaster treating space | | | | |
|---|---|---|---|---|---|---|
| | | Disaster | Interior | | Com- | Adminis- |
| Response space | | scene | space | Garden | munity | trative |
| priority | | (R0) | (R1) | (R2) | (R3) | area (R4) |
| Disaster | Fire | 5 | 5 | 4 | 3 | 2 |
| type | Gas | 5 | 5 | 4 | 4 | 3 |
| | explosion | | | | | |
| | Flood | 5 | 4 | 4 | 2 | 1 |

Disaster response database 42 stores a response notice data 421 corresponding to the disaster types, the disaster hint worsening levels, and the disaster treating spaces. The response notice data 421 includes a tool position TP of a disaster prohibiting tool DT.

The disaster worsening assessing unit 43 assesses a response time limit corresponding to the early-warning period based on the disaster hint worsening level of at least one of the disaster types as shown in the following table 9.

TABLE 9
comparison table of disaster hint worsening
level and response time limit

Disaster type

| | | | |
|---|---|---|---|
| Response time limit (min) | Fire | Gas explosion | Flood |

| | | | | |
|---|---|---|---|---|
| Disaster hint | Safe | — | — | — |
| worsening level | Low | 15 | 20 | 30 |
| | Medium | 3 | 5 | 10 |
| | High | 1 | 2 | 5 |

As mentioned, as the disaster type is fire and the disaster hint worsening level is medium, the disaster worsening assessing unit 43 will make the judgment that the response time limit is 3 min so as to notify the response person 300a that he needs to clear the disaster hint in 3 min as soon as possible or the disaster hint worsening level will proceed to the next level; as the disaster hint worsening level is high, the response person 300a would receive the notice that if he cannot clear the disaster hint in the response time limit, it is suggested to move away from the monitored position MP to prevent damage from the disaster event.

The processing unit 44 is electrically connected to the hint classification database 41, response database 42, and disaster worsening assessing unit 43. As the processing unit 44 determines that the communication device 200a is located in the interior space R1 of the disaster treating spaces, the processing unit 44 will retrieve the communication data 211 of the communication device 200a from the response personnel database 2 and transmit the early-warning signal S1. In addition, as the processing unit 44 determines that a plurality of communication devices 200a, 200b, 200c, 200d, 200e, 200f, and 200g are located in at least one of the disaster treating spaces, the processing unit 44 will decide a communication order of the communication devices 200a, 200b, 200c, 200d, 200e, 200f, and 200g based on person attribute priority and response space priority, retrieve the communication data 211 of the communication devices 200a, 200b, 200c, 200d, 200e, 200f, and 200g based on the communication order and transmit the early-warning signal S1.

As mentioned, for example, as the disaster type is fire and the response person 300a is located in the interior space R1, because the response space priority is the highest priority 5 and the person attribute priority of the response person 300a, who is an adult, is also the highest priority 5, the processing unit 44 will drive the warning communication module 5 using the early-warning signal S1 to transmit the response notice data 421 to the communication device 200a used by the response person 300a in advance.

Afterward, as shown in FIG. 3 and FIG. 4, as the communication device position retrieving module 3 detects that there has no response person in the interior space R1 but detects that there is a communication device 200b used by a response person 300b in the garden R2 as well as a communication device 200c used by a response person 300c and a communication device 200d used by a response person 300d in the community R3, the processing unit 44 will decide which response person should be notified to clear the disaster hint at the monitored position MP based on response space priority and person attribute priority. At this time, if the response person 300b is a child, the response person 300c is a neighbor, and the response person 300d is a relative, although the space priority of response person 300b is higher than that of the response persons 300c and 300d, the processing unit 44 will move to the response persons 300c and 300d in the response space with second space priority, i.e. the community R3, because the response person 300b with the person attribute priority of 0 should be skipped. Then, because the person attribute priority of the response person 300d is higher than the response person 300c, the processing unit 44 will transmit the response notice data 421 to the communication device 200d used by the response person 300b.

In addition, as the disaster type is flood, because the person attribute priority and response space priority of the response person 300b are much higher than the response persons 300c and 300d, the processing unit 44 will decide the communication order based on person attribute priority and response space priority as response person 300b, response person 300d, and response person 300c, and transmit the response notice data 421 to the communication device 200b used by the response person 300b in advance. However, if the response person 300b cannot relief the worsening of disaster hint in the response time limit, the processing unit 44 will further notify the response person 300d, and if the response person 300d cannot relief the worsening of disaster hint in the response time limit, the processing unit 44 will then notify the response persons 300f and 300g in the administrative area R4, wherein the response person 300f is the police office and the response person 300g is the fire department.

If the communication device position retrieving module 3 does not detects any response person in the interior space R1, the garden R2, and the community R3, or the detected response person has the person attribute priority of 0, the processing unit 44 will notify the response person 300f with the communication device 200f located in the administrative area R4 and the response person 300g with the communication device 200g located in the administrative area R4.

The timer 46 is electrically connected to the processing unit 44 and begins to count down by using the real-time estimated remaining time ft as the processing unit 44 transmits the early-warning signal S1 such that the processing unit 44 may determine whether the real-time estimated remaining time ft has moved to the next disaster hint worsening level. In addition, as the processing unit 44 transmits the early-warning signal S1 to the warning communication module 5, the processing unit 44 may drive the warning communication module 5 to transmit the response notice data 421 to the communication device 200a to wake up the timing function of the communication device 200a such that when displaying the response notice data 421, the communication device 200a may also display the real-time estimated remaining time ft provided by the response notice data 421 using a countdown.

As mentioned, the warning communication module 5 is communicated with the processing unit 44 for transmitting the response notice data 421 to the communication devices 200b, 200d, and 200c according to the communication order and the communication data 211 of the different disaster hint worsening levels after receiving the early-warning signal S1. If the communication device 200d transmitted a disaster prohibited signal (not shown) to the primary control module 4, the transmitting condition judging unit 45 will determine that the worsening of disaster hint has stopped based on the disaster prohibited signal and drive the warning communication module 5 to stop transmitting the response notice data 421 to the next communication devices 200d and 200c.

The person position detecting module 6 is communicated with the primary control module, and the person position detecting module 6 includes a human body infrared sensor 61, which is communication with the primary control module 4 for detecting the status of at least one of the response persons. As at least one of the response persons is located in the disaster scene R0 and the status is motion, the primary control module 4 will transmit a stop sensing signal S2 to the sensor 1 to has the sensor 1 stop sensing the disaster hint parameters sp. That is, the disaster hint detected by the sensor 1 at the monitored position MP in the disaster scene R0 would be skipped if certain response person is located in the disaster scene R0.

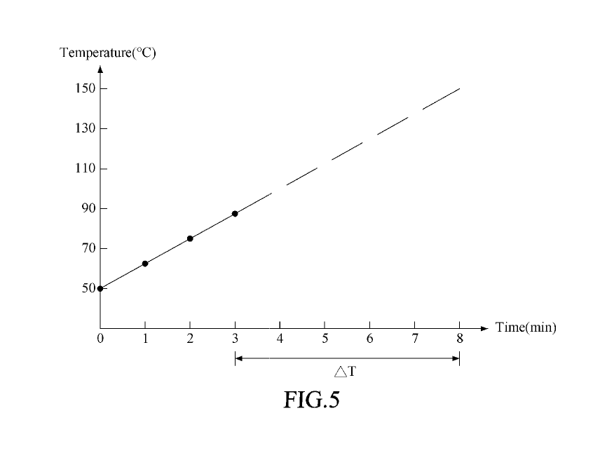

Please refer to FIG. 5, which is a diagram showing the temperature detected by the sensor every minute and the estimated remaining time in accordance with the present invention. As shown, as the detected real-time temperature is 50° C. and the real-time temperature rising speed tr calculated by using the following detected temperature is 20° C. /min, the real-time estimated remaining time ft can be calculated as (150° C.−50° C.)/20° C. /min=5 min by using the real-time temperature and the disaster threshold value t4, that is, if the temperature rising speed tr remains the same, the temperature would reach temperature 150° C. of the disaster threshold value t4 in 5 min.

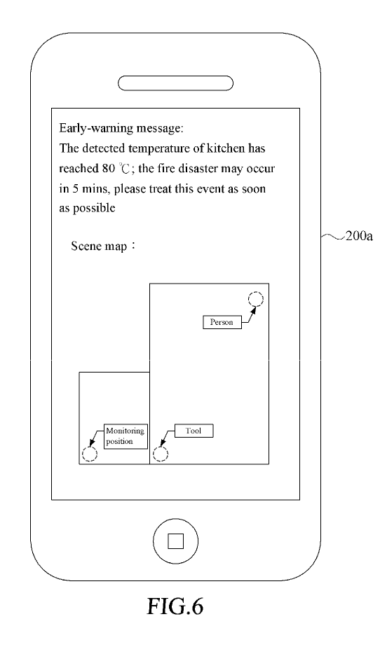

Please keep referring to FIG. 6, which is a planar schematic view showing the communication device displaying the response notice data transmitted by the warning communication module provided in accordance with the present invention. As shown, as the warning communication module 5 transmits the response notice data 421 to the communication device 200a, the communication device 200a will display the response notice data 421, which includes the disaster type, the monitored position MP, the disaster prohibiting tool DT, and the position of the response person 300a using the communication device 200a.

As mentioned, because the primary control module is capable to determine the type, range and remaining time of the disaster based on the detected disaster hints, retrieve the positions of the communication devices used by the response persons by using the communication device position retrieving module so as to transmit the early-warning signal to the communication devices located in the disaster treating space, the response persons can do the corresponding treatments in advance to prevent the happening of disasters effectively.

In addition, even if the response person cannot relief the worsening of disaster hint in the response time limit such that the disaster hint parameters worsens to the higher level, the primary control module is capable to notify the fire department or the police office in the administrative area directly to do the corresponding treatments in time before the disaster hint is worsened to become the disaster event.

While the present invention has been particularly shown and described with reference to a preferred embodiment, it will be understood by those skilled in the art that various changes in form and detail may be without departing from the spirit and scope of the present invention.

What is claimed is:

1. An early-warning system for disasters, used for transmitting an early-warning signal to at least one of a plurality of communication devices during an early-warning period in which a disaster hint is worsened to become a disaster event, wherein the disaster event belongs to at least one of a plurality of disaster types, and the early-warning system comprising:
at least one sensor, utilized for detecting at least one disaster hint parameter at a monitored position corresponding to at least one of the disaster types, and defining a disaster hint worsening level of the early-warning period corresponding to at least one of the disaster types accordingly;
a response personnel database for disasters, recording a plurality of response personnel groups for disasters, each response personnel group being corresponding to at least one of the disaster types and predetermining a personnel attribute priority for at least one of the disaster types respectively such that a plurality of different personnel attribute priorities is predetermined, and each response personnel group recording at least one communication data of the communication device used by at least one response person;
a position retrieving module for communication devices, utilized for detecting a communication device position of the at least one communication device used by the at least one response person for each of the response personnel groups such that a plurality of the communication device positions is retrieved;
a primary control module, communicated with the sensor and the position retrieving module for communication devices, and comprising:
a hint classification database for disasters, having a hint classification rule for disasters, which defines a plurality of disaster treating spaces according to the monitored position, the disaster types, and the disaster hint worsening level corresponding to each of the disaster types, and each of the disaster treating spaces predetermining a response space priority such that a plurality of different response space priorities is predetermined;
a response database for disasters, storing at least one response notice data corresponding to the disaster types, the disaster hint worsening level, and the disaster treating space; and
a processing unit, electrically connected to the hint classification database for disasters, the response database for disasters, and the position retrieving module for communication devices, and deciding a communication order of the communication devices according to the personnel attribute priority and the response space priority when determining that the communication devices are located in at least one of the disaster treating spaces, retrieving the communication data of the communication devices within the disaster treating spaces according to the communication order, and transmitting the early-warning signal; and
a warning communication module, communicated with the processing unit for receiving the early-warning signal and transmitting the response notice data to the communication devices according to the communication order and the communication data.

2. The early-warning system for disasters of claim 1, wherein the response notice data includes at least one tool location of the at least one disaster prohibiting tool.

3. The early-warning system for disasters of claim 1, further comprising a person location detecting module communicated with the primary control module, the person location detecting module including a human body infrared sensor, which is communicated with the primary control module, for detecting status of at least one of the response persons, the disaster treating spaces including a scene, and when at least one of the response persons stays at the disaster scene and the status is motion, the primary control module transmitting a stop sensing signal to the sensor to have the sensor stop sensing the at least one disaster hint parameter.

4. The early-warning system for disasters of claim 1, wherein the primary control module further comprises a transmitting condition judging unit, which has the warning communication module stop transmitting the response notice data when the primary control module receives a prohibited signal transmitted by at least one of the communication devices.

5. The early-warning system for disasters of claim 1, wherein the position retrieving module for communication devices is utilized for detecting positions of the communication devices for each of the response personnel groups by using positioning technologies of the communication devices.

6. The early-warning system for disasters of claim 1, wherein the sensor is an infrared temperature sensor.

7. The early-warning system for disasters of claim 1, wherein the sensor is a gas sensor.

8. The early-warning system for disasters of claim 1, wherein the primary control module further comprises a timer, which is electrically connected to the processing unit and begins to count down when the processing unit transmits the early-warning signal.

9. The early-warning system for disasters of claim 1, wherein when the processing unit determines that one of the communication devices is located in the disaster treating spaces, the processing unit further retrieves the corresponding communication data of the communication devices in the disaster treating spaces, and transmits the early-warning signal.

10. The early-warning system of claim 1, wherein the primary control module further comprises a disaster worsening assessing unit, and the disaster worsening assessing unit accesses a response time limit corresponding to the early-warning period according to the disaster hint worsening level corresponding to at least one of the disaster types.
